(19) United States
(12) Patent Application Publication
(10) Pub. No.: US 2013/0199408 A1
(43) Pub. Date: Aug. 8, 2013

(54) Homogeneous Biodegradable Mixture for Shaped-Bodies: Method for Preparing

(71) Applicant: Ngamtip Poovarodom, Bangkok (TH)

(72) Inventor: Ngamtip Poovarodom, Bangkok (TH)

(21) Appl. No.: 13/806,945

(22) PCT Filed: Jul. 2, 2010
(86) PCT No.: PCT/TH10/00021

§ 371 Date: Dec. 26, 2012

(51) Int. Cl. C08L 3/02

(52) U.S. Cl. CPC C08L 3/02
USPC 106/162.51; 106/206.1; 106/217.01; 106/217.3

(57) ABSTRACT

The method for preparing a homogeneous biodegradable mixture is described for production of shape-bodies. Reinforce fillers are fibers from various natural sources especially those wastes from varieties of manufacturing. Long thin fibers are obtained by longitudinal abrasion of bamboo waste. Boiling the fibers in water for 20 minutes at pH 8 where supernatant is decanted helps getting rid of chlorophyll. Fibers are further ground to preferable length of 2-4 mm. The treated fibers were mixed with all other ingredients in a rotor, spinning at a speed 1,800-2,000 rpm at ambient temperature for 510 minutes. Starch particles and other ingredients penetrate and mix thoroughly with the fibrous materials. Water is gradually added while kneading to form a perfect dough ready for manufacturing of the desired shape bodies.

### TECHNICAL FIELD AND INDUSTRIAL APPLICABILITY FOR THE INVENTION

This invention relates to composition and method for preparing a mixture for shape-bodies to allow uniform dispersion of fiber component throughout the entire matrix with no use of high viscosity fluid and with much less energy consumed for mixing.

1. Field of the Invention

Method for preparation of a mixture for shape bodies having uniformly dispersed fiber component throughout the matrix of the stable articles with improved mechanical properties.

2. Description of Related Art

The present invention relates to method for dispersing fiber uniformly within starch-based composition for shape-bodies. Moreover, this invention presents a significant energy reduction resulting in minimizing the cost of production to be commercially competitive.

### BACKGROUND OF THE INVENTION

The present concern of environment has led to great attempt to use less synthetic non-degradable disposable articles. Many have attempted manufacturing articles of biodegradable, environment-friendly and renewable materials where one of the most often used is starch which is plentiful, natural and renewable. Edible food containers such as trays, cones and cups, have been made to contain a moisture-proof, food grade and barrier coating. Fats or oils are often added to assist in the removal of the shape-bodies from the baking mold. Oxidation of these fats causes these containers to go rancid. In addition, these starch-based containers are generally too brittle and very fragile as they have inadequately low fracture energy and low flexibility strength, as both of which are very important qualities for most packaging materials. The other weak point to use the articles efficiently is that they have a quite poor shelf-life either in the condition that is too dry or too much moisture would result in rottenness and spoilage.

Manufacturers thus attempt to increase strength by filling such starch-based articles with fibers of various lengths (Andersen et al. U.S. Pat. Nos. 5,618,341; 5,679,145; and 6,168,857). One substantial problem of using fiber is the inability to disperse the fibers properly and uniformly throughout the shape-bodies thus result in the very low quality of the starch-based containers. In attempt to prevent clumping of fibers, more liquid component has been used to get better fiber dispersion. Yet, even addition of large quantities of water in such starch-based materials up to 80% did not result in adequate dispersion of fibers of any length as mentioned by Andersen et al (U.S. Pat. No. 5,679,145). Not only ineffective in dispersing even shorter-length fibers, inclusion of such large amount of water leads to great increase in production cost of the articles due to the increased time and energy required to remove the excessive water from the formed product. Thus, in overall, fibers are needed to increase strength of the starch-based articles to be commercially competitive, but the most crucial step to achieve best cost-benefit manufacturing of the biodegradable containers is to disperse fibers evenly throughout the shape-bodies. Such problem has been emphasized in many inventions for manufacturing of starch-based articles. Attempts have further been made incorporating small amounts of inert inorganic fillers within the starch-based composition in order to cut costs for material. However, adding of only small amounts of the inorganic filler is possible, i.e., less than 10% by volume due to sharp decline in mechanical properties and strength of the molded article as the amount of such fillers is increased. Most attempts are failed. All of these are the very significant problems needed to be solved before the starch-based articles could be feasible commercially and used world-wide.

Wang (U.S. Patent Application Publication No. U.S.2009/0255639) disclosed a method for making a biodegradable fibrous material composition emphasizing on stirring a mixture of the softened bamboo fibers, a binder, a solidifying agent, a water repellent, starch and water at a speed ranging from 1,000 to 1,800 rpm/min. However, use of water, 25-35% wt mixing with bamboo powder by stirring at a speed 1,000-1,800 rpm/min, as claimed under a temperature 35-45° C. for 5-30 min to soften bamboo fiber resulted in unevenly dispersing of the fibers in the mixture. This leads to undesirable performance in manufacturing of the shape-bodies.

Andersen and Hodson (U.S. Pat. Nos. 5,618,341 and 5,679,145) in attempt to disperse fiber uniformly within the starch-bound cellular matrix use a two-step mixing process, where a pre-blended mixture is formed by gelating a portion of the starch-based binder or other thickening agent in water to form a liquid phase having high yield stress into which the fibers are attempted to substantially uniformly disperse. Thereafter, the remaining starch-based binder, water, and other components such as mold-release agents, inorganic fillers, rheology-modifying agents, plasticizers, integral coating or sealing materials, and dispersants, are added to the pre-blended mixture to form a moldable starch-based composition. However, this is obviously quite time and energy consuming to disperse the fibers uniformly in any viscous liquid phase. Their disclosed method thus requires many expensive instruments and more labor including its difficulty to achieve effective production of the articles. The cost of production increases tremendously and not commercially competitive in addition that the products would be unacceptable. Moreover, as mentioned in their disclosure, adding of longer length fibers (>2 mm.) in trying to increase the strength of the molded article adversely resulted in no improved properties or even resulted in a weaker article because of very poor dispersion, clumping, and/or segregation of the fibers from the starch-based liquid component of the starting composition. The production of the shape-bodies using their method for dispersion is therefore not possible.

Tanaka (U.S. Patent Application Publication No. U.S.2005/0158541) tried using the water soluble polysaccharide into which the plant fiber powder is dispersed. In his disclosed process, the plant fiber material (60-200 mesh) is washed and sterilized at high temperature using 150 to 180° C. steam where enzymatic action is stopped and the natural color of the plant fiber material is maintained. His invention mixes starch powder, gummy matter powder and water to form plant fiber molding material ready for injection molding. The plant fiber molding material is a moisturized powder and has no flowability until it is injected from the nozzle into the mold. High temperature controlled at 60 to 130° C. is therefore needed to gelatinize the starch and allowing the flow of the material to fill up the mold. Either lower or higher temperature out of this range causes lack of filling into the mold as in the first case the material is not discharged from the injection nozzle of the injection molding machine. In the latter case, at a temperature higher than 130° C., the volume of steam blown out of the nozzle of the injection molding machine increases to cause filling up of end portions of the cavity of the mold with gas, thereby causing lack of filling. Thus, method described by Tanaka is not ideal and not competitive for manufacture as it is not consistent and with low reproducibility.

In overall, so many attempts have been made trying to disperse various length of fibers uniformly throughout the starch-based matrix to increase the strength of the article. So far, using water or liquid phase of greater viscosity did not help solving the problems of clumping thus, results in unacceptable product of very poor properties, in addition to make it quite time and energy consuming thus not commercially feasible.

Poovarodom and Praditdoung (U.S. Pat. No. 7,067,651) disclosed a non-synthetic biodegradable starch-based composition and the process by which this composition is transformed into various foam-liked products. The process has now been successfully improved to increase the strength of the shape-bodies by adding natural fibers that dispersed uniformly throughout the starch matrix with minimal utilization of time and energy.

It would be a tremendous improvement in the art to provide a desirable method for producing homogeneous biodegradable mixture for shape bodies. This method is a great improvement over all the prior arts in term of cost-benefit of the manufacturing process and its reproducibility where no water is added during the mixing. All the ingredients are mixed with the fibers while centrifugation at an appropriate speed allows the starch particles and together with other particulate components to penetrate and mix evenly with the fiber components resulted in a homogeneous bulky mass ready to use. No thickening agent or any viscous liquid phase is needed during the mixing. No clumping is detected in the matrix of the end mixture. Upon adding optimal amount of water while kneading, a perfect dough is obtained ready for transforming into desired shape-bodies.

### SUMMARY OF THE INVENTION

The method for preparing a homogeneous biodegradable mixture is described for production of shape-bodies. Reinforce fillers are needed to increase strength of the containers to make it commercially acceptable. Fibers from various natural sources especially those waste from varieties of manufacturing are applicable as filler. Fibrous materials used is the waste obtained from bamboo article manufacture. Long thin fibers are obtained. The treatment is boiling the fibers in water for 20 minutes at pH 8 where supernatant is decanted to get rid of chlorophyll. Fibers are further ground to preferable length of 2-4 mm. The treated fibers were mixed with all other ingredients in a rotor, spinning at a speed 1,800-2,000 rpm at ambient temperature for 5-10 minutes. Starch particles and other ingredients penetrate and mix well with the fibrous materials. Gradual adding of water to the dry mixture while kneading results in dough with best properties for production of shape-bodies. The dry mixture can be kept at ambient temperature for at least 6 months before use.

### DETAILED DESCRIPTION OF THE PREFERRED EMBODIMENTS

The present invention described a method for mixing the ingredients for forming biodegradable shape bodies with natural fibers to obtain a homogeneous mixture with virtually no clumping of the fiber components throughout the matrix. The mixture is ready for further processing. A great additional advantage is a considerable long shelf-life of the dry mix up to 6 months before being kneaded with appropriate amount of water (0.5-1.0 fold). This is not possible by all the mixtures described in the prior arts using liquid dispersants which, in addition, is not possible for even a short time of storage including taking too much room if stored.

In the present disclosure, the natural fibers used to increase the strength of the shape-bodies can be waste from manufactures such as furniture and wood or food manufactures, eg. fruit pulp, fruit skin, rice bran, nutshell, cassava pulp, and etc. The best would be waste from bamboo, or other of the grass family-Poaceae, appropriate plants of Cyperaceae family. Any fibers having cellulose 40% and up is most desirable, where hemicelluloses and extraneous substances may act as binder for fibers within the continuous matrix. Fibers are obtained by longitudinal abrasion through grinding of the bamboo waste from manufacturing which otherwise needs to be burnt away and worsens the global warming problems. Fibers are boiled in water for 20 minutes at pH 8 and supernatant is decanted thus getting rid of chlorophyll and pigments. The fibers with moisture of 20-30% wt are further ground to a final length of 2-4 mm having moisture of 8-12% wt. The treated fibers mix well with all other ingredients in a rotor, spinning at a speed 1,800-2,000 rpm at ambient temperature for 5-10 minutes.

Without water, the centrifugal force allows starch particles and other ingredients satisfactorily penetrating through uniformly and mixing thoroughly with the fibers part. This is a dry mixing which is the significant difference from all the prior arts and very efficient in terms of time and energy utilized to make the process commercially competitive with great reproducibility, resulting in the end product mixture of best properties. Appropriate amount of water, approximately 0.5-1.0 fold by weight, preferably 0.6 fold by weight, is gradually added while kneading to form a perfect dough ready for manufacturing of the desired shape-bodies. Use of waste from various industries to make useful products helps in the aspect of environmental saving which otherwise may cost tremendously to get rid of which is presently a very big problem to environment.

### Example 1

### Composition for Shape Bodies (% by Weight)

| | |
|---|---|
| Starch | 30-70% |
| Plasticizers | 0-10% |
| Reinforcing fillers | 5-30% |
| Binders | 0-5% |
| Alkali or salt | 0.1-0.5% |
| Water to make | 100% |

Starch can be those prepared from cassava, rice, glutinous rice, sweet potato, corn, potato, sorghum or sago, either singly or as mixture, in form of flour or starch or modified starch. Plasticizers are selected from the following groups consisting of polyols which are glycerol or sorbitol, or saccharides which are sugar, glucose, fructose, glucose syrup and honey; or lipids or their derivatives which are fatty acid, fatty acid esters, monoglycerides, diglycerides, distilled acetylated monoglyceride or phospholipid, which may be used singly or as mixture. Reinforcing filler are selected from the groups consisting of natural fibrous materials such as fibers from bamboo, or grasses of family Poaceae or Cyperaceae, cassava pulp and inert porous powder such as limestone, diatomaceous earth, bentonite, zeolite, talcum and may be used singly or as mixture. Binder used is selected from the following groups consisting of hydrocolloids which are alginate, gum, agar, carrageenan and konjak flour, which may be used singly or as mixture. Alkali or salt is selected from calcium hydroxide, sodium hydroxide, potassium hydroxide, calcium carbonate, sodium carbonate, potassium carbonate, ammonium carbonate, sodium bicarbonate and ammonium bicarbonate, which may be used singly or as mixture added to make the pH of the mixture close to neutral or slightly alkaline.

Continuous matrix of the shape bodies is starch or flour in the range of 30-70% where cassava pulp from manufacturing waste can substitute these starch or flour which helps decreasing the cost of production.

The great improvement of the presently disclosed method for preparing the homogeneous biodegradable mixture for production of the shape-bodies is dry mixing, which gives much better product over those prior arts using liquid dispersants. Use of liquid dispersants is the attempt trying to overcome the problems of clumping of fibrous materials which adversely resulted in very poor products of unacceptable properties. The present invention, therefore, offers an uncomplicated process for dispersion of the fibrous materials throughout a continuous matrix of the shape bodies with no need of expensive or sophisticated equipments and minimizing the operating cost in addition to minimizing the inconsistency occurred during the production process thus allowing the manufacturing of the shape-bodies to be best and most efficient. The mixture can be stored using minimum space at ambient temperature until use having as long shelf-life up to at least 6 months which is very helpful to cut cost of production, where storage for a certain period of time is otherwise impossible by those using liquid dispersants.

The strengthened containers or articles having fibrous materials dispersed uniformly produced by the presently disclosed invention do not contain any synthetic non-degradable polymers or resin at all. They are therefore friendly in the natural environment as being biodegraded to disperse and become a component of soil. Thus, they can be disposed of as ordinary organic wastes with no violation of the container recycle law.

The present invention provides a method for preparing a homogeneous biodegradable mixture for shape-bodies having fibers of appropriate length dispersed uniformly throughout the continuous matrix. The process consumes minimum time and energy but yields products of best properties especially strength. The present invention may be embodied in other specific forms without departing from the scope of this invention by one of ordinary skill in the art. It is accordingly intended that all matter contained in the above description be interpreted as descriptive rather than in a limiting sense.

It is also to be understood that the following claims are intended to cover all of the generic and specific features of the invention as described herein, and all statements of the scope of the invention which, as a matter of language, might be said to fall therebetween.

I claim:

1. Method for preparing a homogeneous biodegradable mixture for production of shape-bodies having desirable strength comprises step of dispersing fibrous reinforcing fillers uniformly by dry mixing fibers with all other ingredients using centrifugal force.

2. Method for preparing a homogeneous biodegradable mixture for production of shape-bodies of claim 1 where fibrous reinforcing fillers prepared from bamboo or other grasses of family-Poaceae, or Cyperaceae or waste from the wood or food industries and where fibers are obtained by longitudinal abrasion of bamboo.

3. Method for preparing a homogeneous biodegradable mixture of claim 2 where fibrous reinforcing fillers are of 2-4 mm in length.

4. Method for preparing a homogeneous biodegradable mixture of claim 1 where centrifugal force used is 1,800-2,000 rpm at ambient temperature for 5-10 minutes.

5. Method for preparing a homogeneous biodegradable mixture of claim 1 where all other ingredients are

| | |
|---|---|
| Starch | 30-70% |
| Plasticizers | 0-10% |
| Binders | 0-5% |
| Alkali or salt | 0.1-0.5% |
| Water to make | 100% |

6. Method for preparing a homogeneous biodegradable mixture of claim 1 where said fibrous reinforcing fillers make up 5-30% of the composition.

7. Method for preparing a homogeneous biodegradable mixture of claim 1 where reinforcing fillers are selected from groups of natural fibrous materials such as fibers from bamboo, or grasses of family Poaceae or Cyperaceae, cassava pulp and inert porous powder such as limestone, diatomaceous earth, bentonite, zeolite, talcum, which may be used alone or as mixtures.
